(19) United States
(12) Patent Application Publication
(10) Pub. No.: US 2013/0216303 A1
(43) Pub. Date: Aug. 22, 2013

(54) Positioning assembly able to position electrical card

(71) Applicants: Jin-Song Tang, Shenzhen (CN); Wen-Chih Jai, Taipei City (TW)

(72) Inventors: Jin-Song Tang, Shenzhen (CN); Wen-Chih Jai, Taipei City (TW)

(73) Assignee: COMPUPACK TECHNOLOGY CO., LTD, Taipei City (TW)

(21) Appl. No.: 13/401,620

(22) Filed: Feb. 21, 2012

(51) Int. Cl. F16B 2/20

(52) U.S. Cl. 403/326

(57) ABSTRACT

The positioning assembly able to position electrical card is disposed on a printed circuit board able to be connected with electrical card, and comprising: a base unit and a spring unit, wherein the base unit further includes a base body, and a spring accommodating space disposed on one side of the base body; the spring unit further includes an inserting portion able to insert into the spring accommodating space and a pressing portion extendedly formed on one end of the inserting portion, thus the torque formed on the spring unit can be small after the pressing portion of the spring unit being acted, and the spring unit is not broken easily. Two first protruding blocks of the inserting portion are able to be engaged at two blocking portions of the spring accommodating space, so that the spring unit can be assembled with the base unit steadily;

### BACKGROUND OF THE INVENTION

1. Technical Field

The present invention relates to a positioning assembly able to position electrical card, and more particularly, to a positioning assembly disposed on printed circuit board is capable of positioning an electrical card connected with the printed circuit board.

2. Description of Related Art

Electrical card connection device is generally disposed in many electrical systems for upgrading new software, or installing various software requested by the necessity of client. The electrical card connection device is able to connect with any electrical cards electrically for transferring information between the electrical cards and the electrical systems, and basically includes one connector able to communicate with the electrical cards and at least two conventional electrical card positioning assemblies, wherein the connector is a kind of media capable of connecting with the electrical card, and the conventional electrical card positioning assemblies are capable of positioning electrical card.

Please refer to FIG. 1A, shown a stereo view of conventional electrical card positioning assembly, a conventional electrical card positioning assembly P1 includes a fixing base P11 and a locking member P12, the fixing base P11 includes a positioning unit P111 and a inserted slot P112, the locking member P12 includes a locking portion P121. A positioning space is formed between the positioning unit P111 and the locking portion P121 when the locking member P12 assembles with the fixing base P11. As shown in figure, an electrical card P2 is disposed at the positioning space after the electrical card P2 presses on the conventional electrical card positioning assembly P1, wherein the electrical card P2 is able to be positioned when the positioning unit P111 passing through a fixing hole of the electrical card P2, also, the electrical card P2 is locked by the locking portion P121, and being fixed on the conventional electrical card positioning assembly P1.

Please refer to FIG. 1B, shown an exploded view of conventional electrical card positioning assembly, as shown in figure, two shoulder portion P122 are formed at two opposite sides of the locking member P12, so that, a static friction can be produced between shoulder portion P122 and the inner surface of the inserted slot P112 when the locking member P12 accommodated inside the inserted slot P112, thus the locking member P12 does not easily be pulled out from the inserted slot P112.

So that, through above descriptions, it is able to know that the constituting elements and the structure thereof of the conventional electrical card positioning assembly, moreover, it can also find that the conventional electrical card positioning assembly includes the drawbacks and the shortcomings as follows:

1. Locking member broken easily: a pressing force acts on one surface of the locking portion P121 when the electrical card P2 is located at the positioning space, and the locking member P12 deforms along with one side of the inserted slot P112, then one torque formed at a deformation line P123 of the locking member P12 by the pressing force is able to produce a deformation of the locking member P12, and the locking member P12 is easily broken by the deformation.

2. Pull out easily: the locking member P12 can be fixed in the fixing base P11 by the friction produced between shoulder portion P122 and the inner surface of the inserted slot P112; however, the friction is easily decreased by age, and sometimes is unable to resist the pulling acted at the locking member P12, thus, the locking member P12 is easily pulled out from the fixing base P11.

Accordingly, in view of the conventional electrical card positioning assembly still has shortcomings and drawbacks, the inventor of the present application has made great efforts to make inventive research thereon and eventually provided a positioning assembly able to position electrical card.

### BRIEF SUMMARY OF THE INVENTION

The primary objective of the present invention is to provide a positioning assembly able to position electrical card, in which, the structure of the base unit and the spring unit are capable of positioning an electrical card on a printed circuit board, and the spring unit is not easily broken by the deformation.

The another objective of the present invention is to provide a positioning assembly able to position electrical card, in which, the spring unit has two blocking holes and two third protruding blocks, so that the spring unit is not easily pulled out from the base unit, and being assembled with the base unit steadily.

Accordingly, to achieve the above objectives of the present invention, the inventor proposes a positioning assembly able to position electrical card, being disposed on a printed circuit board with a connector, and an electrical card being able to position on the printed circuit board when the connector is connecting with the electrical card, the positioning assembly able to position electrical card comprising: a base unit, comprising: a base body; a positioning post, being disposed on one side of the base body, and fitted a positioning hole of the electrical card; a spring accommodating space, being formed on the side of the base body with the positioning post, wherein two opposite inner surfaces of the spring accommodating space have at least one blocking portion, respectively; and a groove, being formed on one side of the base body, and connected with the spring accommodating space; a spring unit, comprising: an inserting portion, being able to insert into the spring accommodating space, and having at least two first protruding blocks formed on two opposite sides thereof, wherein the first protruding blocks of the inserting portion are engaged at the blocking portions of the spring accommodating space when the inserting portion is inserting into the spring accommodating space; a pressing portion, being extendedly formed on one end of the inserting portion, and pressing the surface of the electrical card when the electrical card is positioned on the printed circuit board; and a fixing portion, being extendedly formed on another end of the inserting portion, and accommodating in the groove after passing through the spring accommodating space; and at least one fixing unit, being disposed on the bottom side of the base unit.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1A is a stereo view of conventional electrical card positioning assembly;

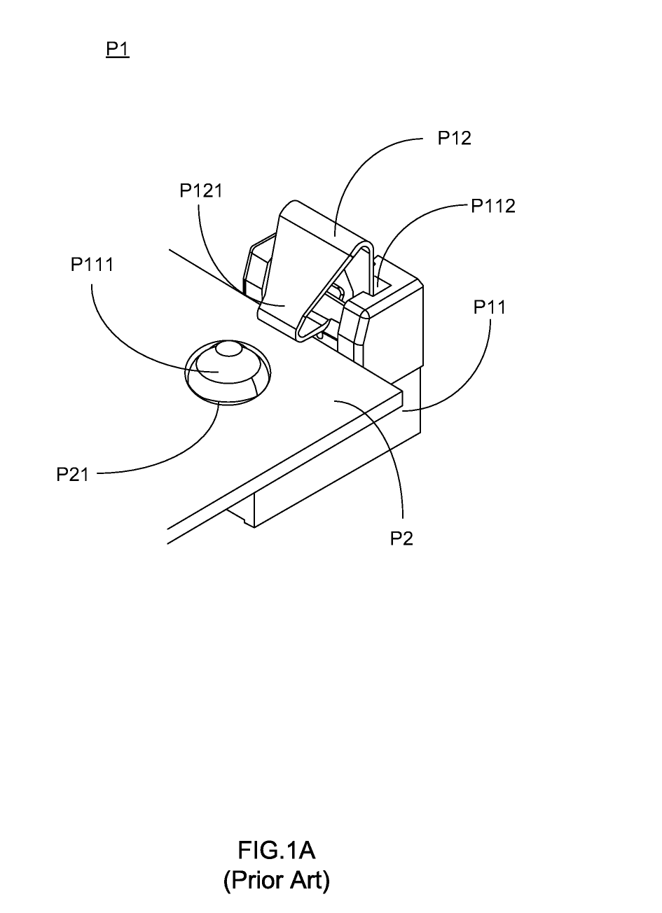

FIG. 1B is an exploded view of conventional electrical card positioning assembly;

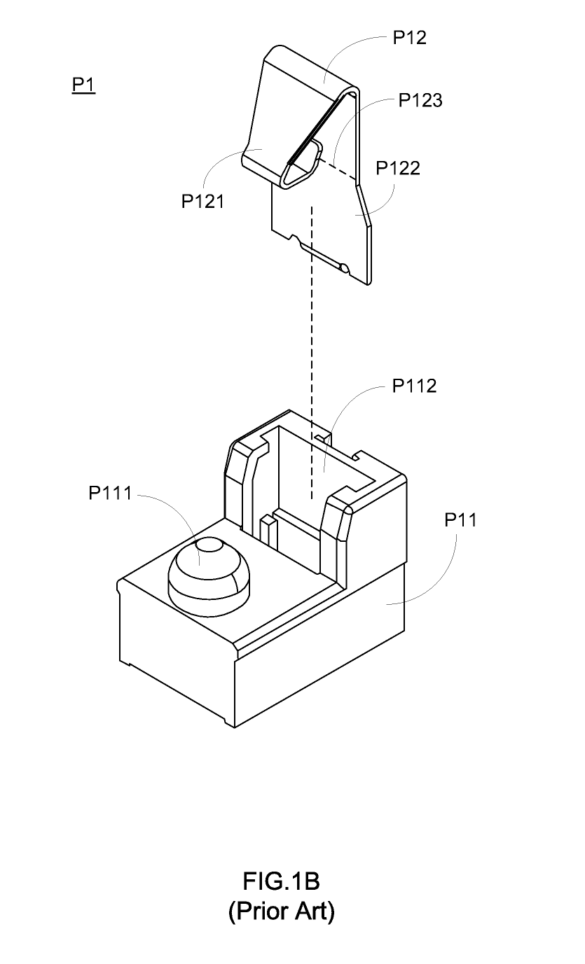

FIG. 2 is an exploded view of the positioning assembly able to position electrical card according to the present invention;

FIG. 3 is a stereo view of the positioning assembly able to position electrical card disposed on printed circuit board;

FIG. 4A is a first stereo view of the spring unit of the present invention;

FIG. 4B is a second stereo view of the spring unit of the present invention;

FIG. 5A is a front lateral cross sectional view of the positioning assembly able to position electrical card according to the present invention;

FIG. 5B is a side lateral cross sectional view of the positioning assembly able to position electrical card according to the present invention;

FIG. 6 is a rear stereo view of the positioning assembly able to position electrical card according to the present invention;

FIG. 7 is a stereo view of the positioning assembly able to position electrical card according to the present invention; and

FIG. 8A and FIG. 8B are action diagram of the electrical card positioned on the printed circuit board.

### DETAILED DESCRIPTION OF THE INVENTION

To more clearly describe a positioning assembly able to position electrical card according to the present invention, embodiments of the present invention will be described in detail with reference to the attached drawings hereinafter.

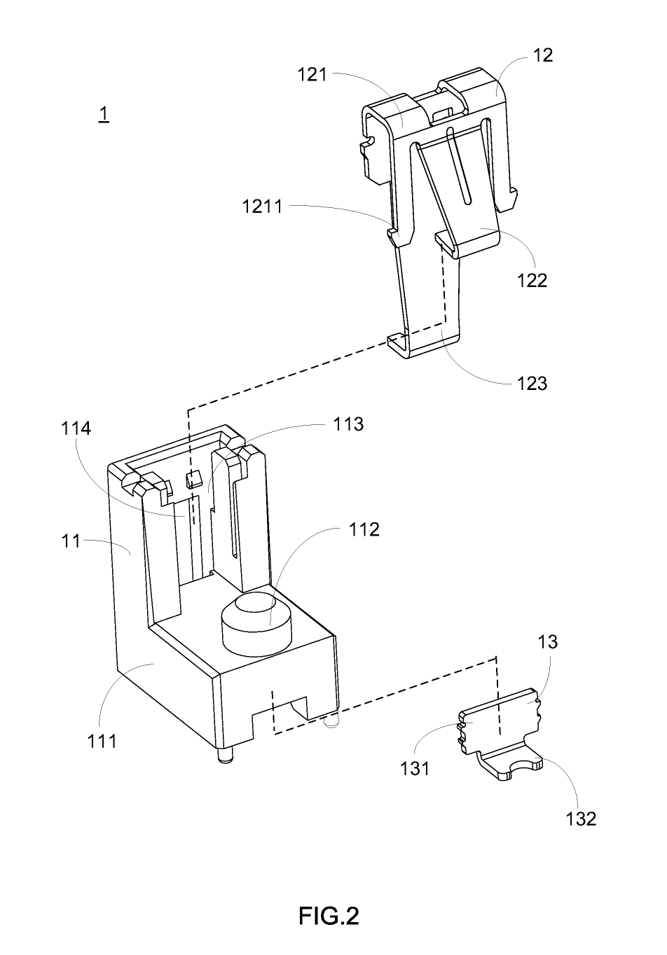

Please refer to FIG. 2, there is shown an exploded view of the positioning assembly able to position electrical card according to the present invention. As shown in FIG. 2, the positioning assembly able to position electrical card 1: a base unit 11, a spring unit 12 and a fixing unit 13, wherein the base unit 11 further includes a base body 111 which is L shape; a positioning post 112, being disposed on one side of the base body 111; a spring accommodating space 113, being formed on the side of the base body 111 with the positioning post 112; a groove 114, being formed on one side of the base body 111, and connected with the spring accommodating space 113. The spring unit 12 further includes an inserting portion 121, having at least two first protruding blocks 1211 formed on two opposite sides thereof, wherein the lateral side of the inserting portion 121 is inverted U-shape; a pressing portion 122, being extendedly formed on one end of the inserting portion 121; a fixing portion 123 opposite to the pressing portion 122, being extendedly formed on one end of the inserting portion 121, and accommodating in the groove 114 after passing through the spring accommodating space 113; and a fixing unit 13 being disposed on the bottom side of the base unit 11.

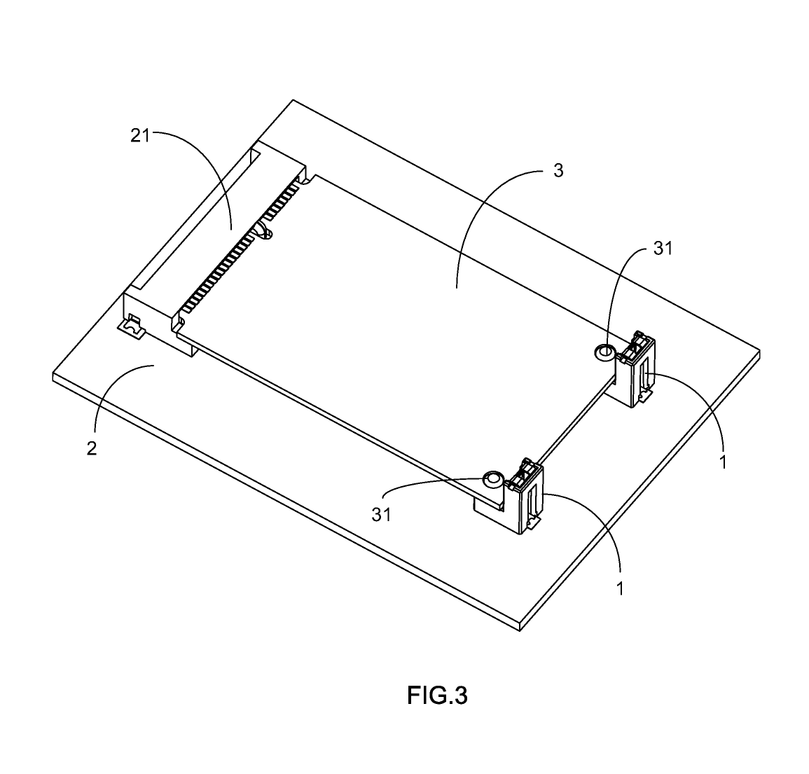

Please refer to FIG. 3, there is shown a stereo view of the positioning assembly able to position electrical card disposed on printed circuit board, and demonstrating an application of the present invention, and also refer to FIG. 2. In the application, two positioning assembly able to position electrical card 1 are disposed on a printed circuit board 2 with a connector 21, and an electrical card 3 capable of being positioned by the positioning assembly able to position electrical card 1 has two positioning hole 31 and is connected with the connector 21 steadily. The positioning posts 112 can be fitted the positioning holes 3 when the electrical card 3 is positioned on the printed circuit board 2, at the mean time, the pressing portion 3 presses the surface of the electrical card 3 above the positioning posts 112; the pressing portion 112 is away from the surface of the electrical card 3 when suffering a force, so that, the electrical card 3 can be removed from the printed circuit board 2.

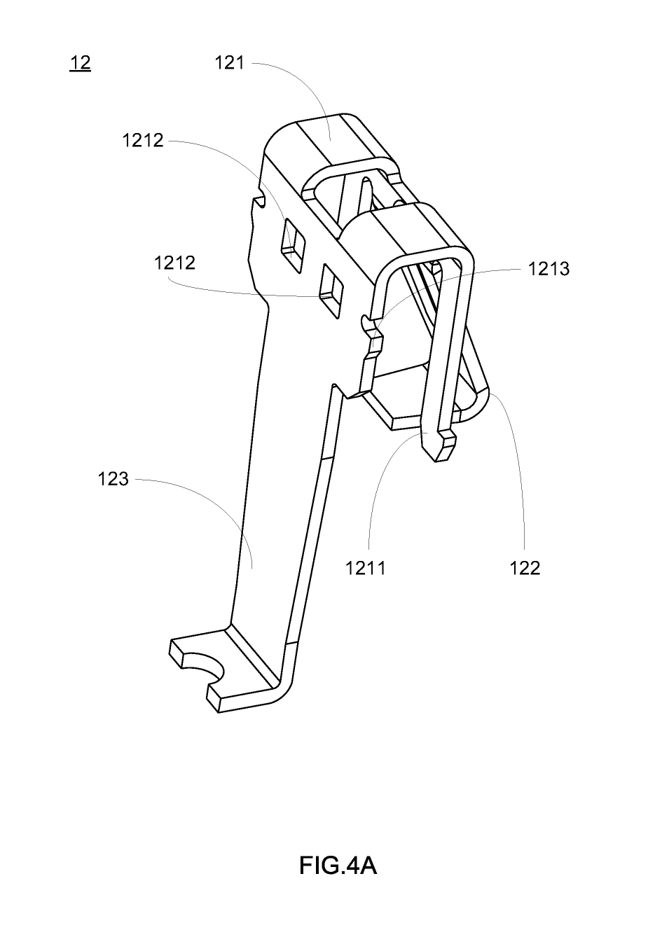

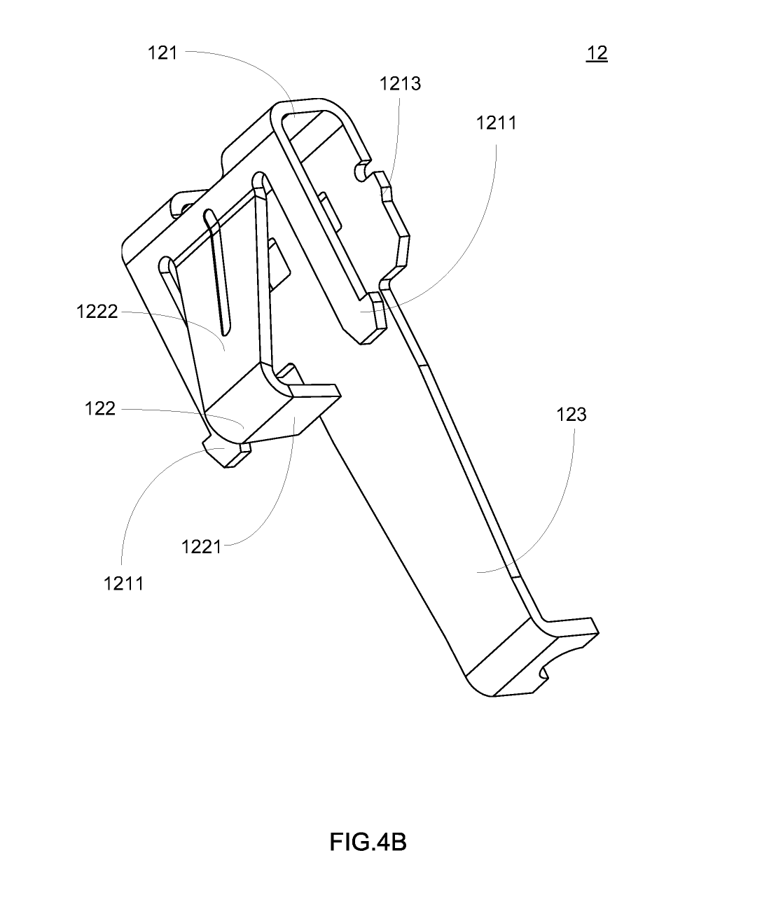

For more clearly describing the spring unit of the present invention, please refer to FIG. 4A and FIG. 4B, are shown a first stereo view of the spring unit of the present invention and a second first stereo view of the spring unit of the present invention, respectively. Please also refer to FIG. 3, two first protruding blocks 1211 are formed and extended downward on two opposite sides of the inserting portion 121; two third protruding blocks 1213 is opposite to the first protruding blocks 1211 and formed on opposite sides of the inserting portion 121; the pressing portion 122 further includes a first pressing surface 1221 and a second pressing surface 1222, wherein the first pressing surface 1221 presses the electrical card 3 when the electrical card 3 is positioned on the printed circuit board 2; moreover, the pressing portion 122 deforms and the first pressing surface 1221 is away from the surface of the electrical card 3 when the second pressing surface 1222 suffering a force, so that, the electrical card 3 can be removed from the printed circuit board 2. In addition, FIG. 4A has shown the inserting portion 121 further includes two blocking holes 1212 formed on one side thereof.

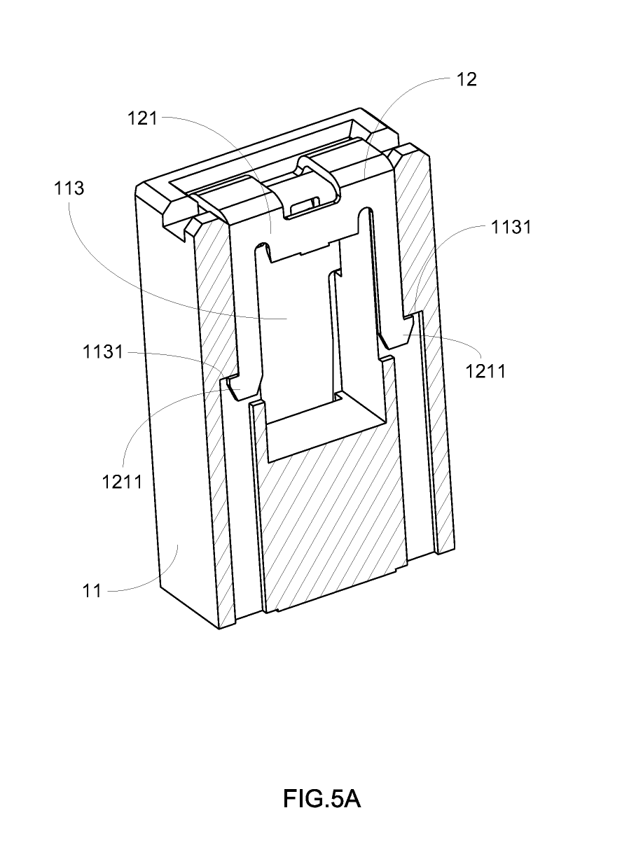

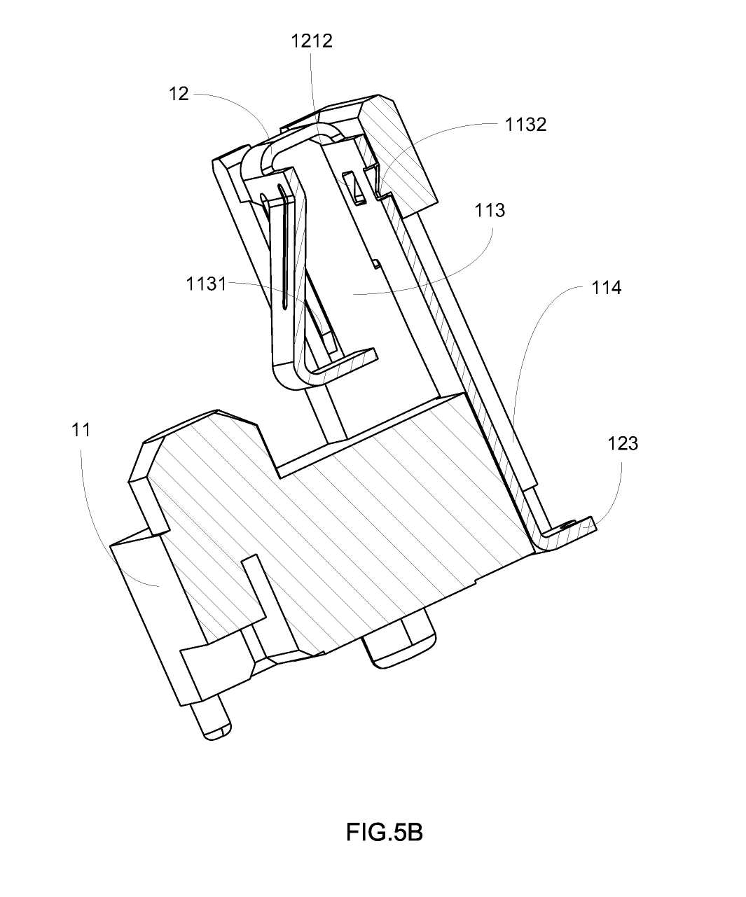

Please refer to FIG. 5A and FIG. 5B, are shown a front lateral cross sectional view of the positioning assembly able to position electrical card according to the present invention, and a side lateral cross sectional view of the positioning assembly able to position electrical card according to the present invention, respectively. Please also refer to FIG. 4A, two opposite inner surfaces of the spring accommodating space 113 have at least one blocking portion 1131, respectively. The inserting portion 121 of the spring unit 12 is plugged into the spring accommodating space 113 and the third protruding blocks 1211 of the inserting portion 121 can be embedded into the blocking portion 1131 of the spring accommodating space 113 when the spring unit 12 is assembled with the base unit 11, thus, the spring unit 12 can be fixed inside the base body 11 steadily by the first protruding blocks 1211 and the third protruding blocks 1213. As shown in FIG. 5B, the spring accommodating space 113 further includes two second protruding blocks 1132 formed on two opposite inner surfaces thereof, and the two second protruding blocks 1132 are engaged at the two blocking holes 1212 of the inserting portion 121 when the spring unit 12 is assembled with the base unit 11, so that, the spring unit 12 can be fixed inside the base body 11 steadily.

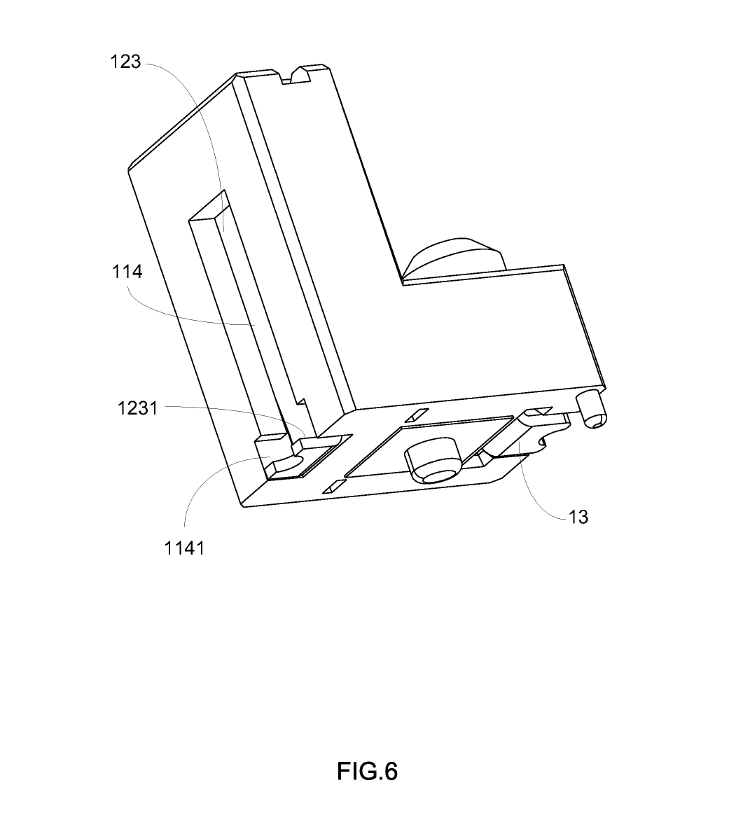

Please refer to FIG. 6, there is shown a rear stereo view of the positioning assembly able to position electrical card according to the present invention. Please also refer to FIG. 2, the groove 114 of the base unit 11 further includes a first slot 1141 formed at the bottom of the base body 111, thus a fixing end 1231 of the fixing portion 123 is able to pass through the first slot 1141 of the groove 114, and protruding out of the bottom of the base body 111. In addition, the fixing unit further includes a first end 131 and a second end 132, wherein the first end 131 is embedded into the bottom of the base body 111.

Please inherit to above, and referring to FIG. 3, the positioning assembly able to position electrical card 1 according to the present invention can be positioned on printed circuit board 2 by the fixing end 1231 of the fixing portion 123 and the second end 132, as shown in FIG. 6, the embodiment applied by the present invention demonstrates the positioning assembly able to position electrical card 1 fixed on the printed circuit board 2 by the way of surface mount technology, thus, the fixing end 1231 of the fixing portion 123 and the second end 132 are bending and able to stay on the surface of the printed circuit board 2 to proceed surface mount technology. However, the embodiment is not intended to limit scope of the positioning assembly able to position electrical card of the present invention, the positioning assembly able to position electrical card 1 of the present invention can also be fixed on the printed circuit board 2 by the way of dual in-line when the fixing end 1231 of the fixing portion 123 and the second end 132 are pin-type.

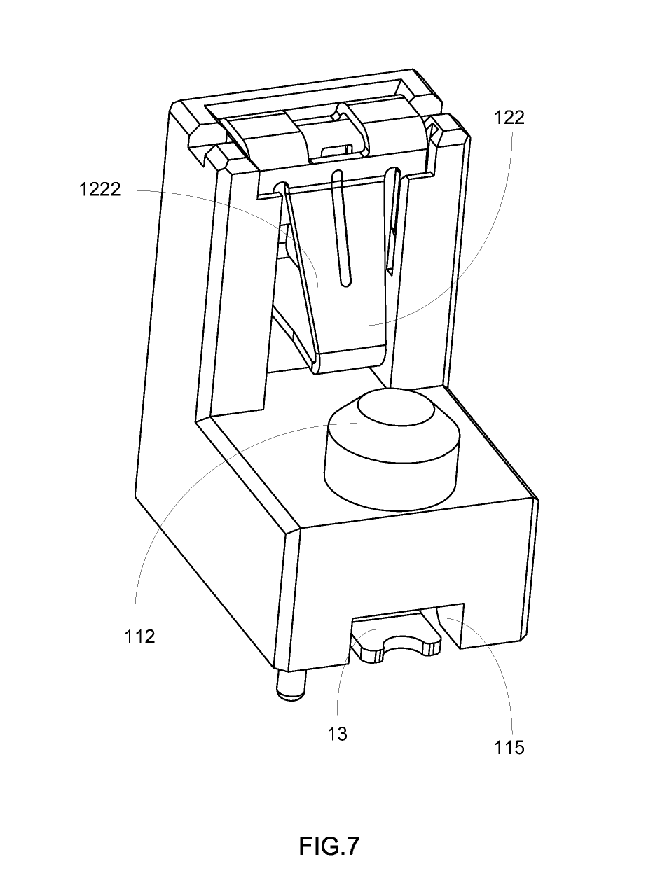

Please refer to FIG. 7, there is shown a stereo view of the positioning assembly able to position electrical card according to the present invention, a second slot 115 formed on one side of the base body 111 is opposite to the positioning post 112, thus, the fixing unit 13 can be inserted into the second slot 115, and is able to proceed welding in the second slot 115; and the positioning hole of the electrical card can pass through the chamfer of the positioning post 112 conveniently.

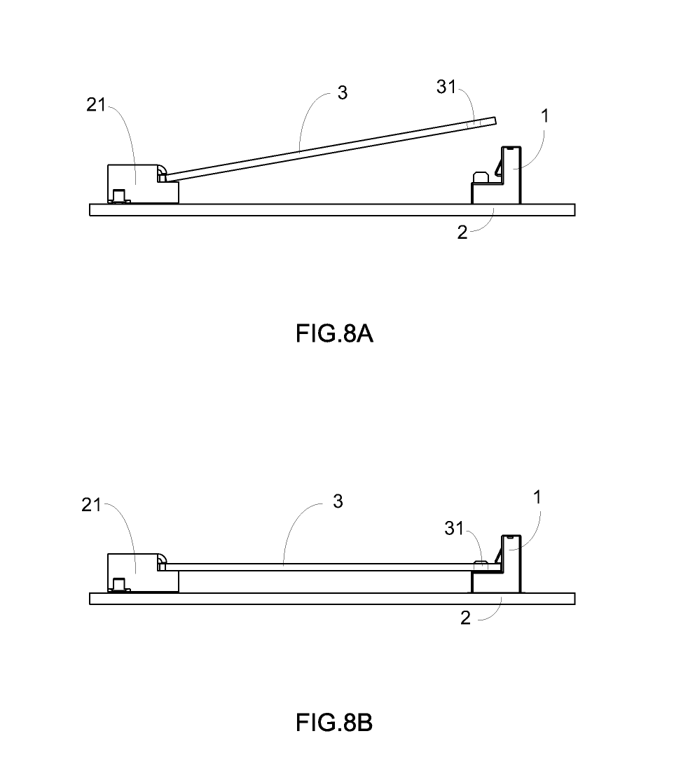

Please refer to FIG. 8A and FIG. 8B, are shown action diagram of the electrical card positioned on the printed circuit board. please also refer to FIG. 7, the electrical card 3 is slightly slanted on the printed circuit board 2, and plugged into the connector 21, then, as shown in FIG. 8B, the pressing portion 122 is deforming due to the electrical card 3 pressed down on the first pressing surface 1221, and the pressing portion 122 can be returning after the positioning post 112 is located in the positioning hole 31 of the electrical card 3 completely, and pressing on the surface of the electrical card 3, so that, the electrical card 3 is positioned on the printed circuit board 2.

Therefore, the above descriptions have been clearly and completely introduced the positioning assembly able to position electrical card of the present invention; in summary, the present invention has the following advantages:

1. the spring unit is not broken easily: In the present invention, the pressing portion of the spring unit is extendedly formed on one end of the inserting portion, the inserting portion is plugged into the spring accommodating space, the torque is smaller then the conventional electrical card positioning assembly after the pressing portion of the spring unit being acted, thus, the spring unit of the present invention is not broken easily.

2. the spring unit is not pulled out of base unit easily: In the present invention, the spring unit has two first protruding blocks and two third protruding blocks, also, the second protruding blocks can be engaged at the blocking holes of the inserting portion, so that, the spring unit can be assembled with the base unit steadily, and being unable to be pulled out of the base unit easily.

The above description is made on embodiments of the present invention. However, the embodiments are not intended to limit scope of the present invention, and all equivalent implementations or alterations within the spirit of the present invention still fall within the scope of the present invention.

We claim:

1. A positioning assembly able to position electrical card, being disposed on a printed circuit board with a connector, and an electrical card being able to position on the printed circuit board when the connector connecting with the electrical card, the positioning assembly able to position electrical card comprising:
a base unit, comprising:
a base body;
a positioning post, being disposed on one side of the base body, and able to be fitted a positioning hole of the electrical card;
a spring accommodating space, being formed on the side of the base body with the positioning post, wherein two opposite inner surfaces of the spring accommodating space have at least one blocking portion, respectively; and
a groove, being formed on one side of the base body, and connected with the spring accommodating space;
a spring unit, comprising:
an inserting portion, being able to insert into the spring accommodating space, and having at least two first protruding blocks formed on two opposite sides thereof, wherein the first protruding blocks of the inserting portion can be engaged at the blocking portions of the spring accommodating space when the inserting portion is inserting into the spring accommodating space;
a pressing portion, being extendedly formed on one end of the inserting portion, and capable of pressing the surface of the electrical card when the electrical card being positioned on the printed circuit board; and
a fixing portion, being extendedly formed on another end of the inserting portion, and accommodating in the groove after passing through the spring accommodating space; and
at least one fixing unit, being disposed on the bottom side of the base unit.

2. The positioning assembly able to position electrical card of claim 1, wherein the base unit is L shape, and the groove of the base unit further includes a first slot formed at the bottom of the base body.

3. The positioning assembly able to position electrical card of claim 2, wherein a fixing end of the fixing portion passed through the first slot of the groove protrudes at the bottom of the base body, and is capable of fixing on the printed circuit board by the way of: surface mount technology and dual in-line.

4. The positioning assembly able to position electrical card of claim 1, wherein the pressing portion further includes a first pressing surface and a second pressing surface, wherein the first pressing surface is capable of pressing the electrical card when the electrical card is positioned on the printed circuit board; moreover, the pressing portion deforms, and the first pressing surface is away from the surface of the electrical card when the second pressing surface suffers a force, so that, the electrical card can be removed from the printed circuit board.

5. The positioning assembly able to position electrical card of claim 3, wherein the fixing unit further includes a first end and a second end, the first end is embedded into the bottom of the base body; moreover, when the fixing end of the fixing portion is connected on the printed circuit board by the way of surface mount technology, then the second end is correspondingly connected on the printed circuit board by the way of surface mount technology.

6. The positioning assembly able to position electrical card of claim 3, wherein the fixing unit further includes a first end and a second end, the first end is embedded into the bottom of the base body; moreover, when the fixing end of the fixing portion is connected on the printed circuit board by the way of dual in-line, then the second end is correspondingly connected on the printed circuit board by the way of dual in-line.

7. The positioning assembly able to position electrical card of claim 1, wherein the inserting portion further includes two blocking holes formed on one side thereof.

8. The positioning assembly able to position electrical card of claim 7, wherein the spring accommodating space further includes two second protruding blocks formed on two opposite inner surfaces thereof, and the two second protruding blocks are engaged at the two blocking holes of the inserting portion when the spring unit is assembled with the base unit.

9. The positioning assembly able to position electrical card of claim 1, wherein the inserting portion further includes two third protruding blocks formed on opposite sides thereof, the two third protruding blocks can be embedded into the spring accommodating space when the spring unit is assembled with the base unit.
